(19) United States
(12) Patent Application Publication
(10) Pub. No.: US 2023/0103447 A1
(43) Pub. Date: Apr. 6, 2023

(54) Apparatus, Device, Method, and Computer Program for Managing Memory

(71) Applicant: Intel Corporation, Santa Clara, CA (US)

(72) Inventors: Sreenivas SUBRAMONEY, Bangalore (IN); Wajdi FEGHALI, Boston, MA (US); Aravinda PRASAD, Bangalore (IN); Alan NAIR, Pathanapuram (IN)

(21) Appl. No.: 18/058,282

(22) Filed: Nov. 23, 2022

(51) Int. Cl. G06F 9/455; G06F 9/4401

(52) U.S. Cl. CPC G06F 9/45558; G06F 9/4406; G06F 2009/45583; G06F 2009/4557

(57) ABSTRACT

Examples relate to an apparatus, device, method, and computer program for managing memory, and to a computer system comprising such an apparatus or device. The method comprises determining an impending access to a functionality provided by a virtual machine. The method comprises restoring a subset of memory pages associated with the virtual machine from a compressed memory pool to uncompressed memory according to a memory restoration template after determining the impending access to the virtual machine.

### BACKGROUND

Function as a Service (FaaS) is a rapidly emerging cloud-native workload where each function (a small portion of application logic) runs in isolation inside a virtual machine (VM). Cloud service providers (CSPs) typically have thousands of active function instances (i.e., VMs) running on a single physical machine. In general, CSPs try to ensure that they can pack as many VMs as possible on a single physical machine to maximize system utilization. This brings up additional challenges in terms of resource management, and in particular memory management, because unlike CPU (Central Processing Unit) cycles, VMs consume memory even when they are idle. This limits the number of VM instances that can be spawned on a system.

However, increasing the memory capacity of data center servers is at with the economics of operating a cloud, as, according to some research reports, memory costs account for approximately half of the Total Cost of Ownership (TCO) of a datacenter while the CPU costs account for less than 20%. This may put a limit on the total addressable market of processor manufacturers in the datacenter market.

To address the increasing memory inefficiencies in cloud environments, an idle VM's pages can be placed in a compressed memory pool, such as ZSWAP. ZSWAP is a Linux kernel feature for providing a compressed Random Access Memory (RAM) cache for swap pages. This can effectively boost the memory capacity, allowing a CSP to spawn more VMs per gigabytes of memory. However, when a FaaS function is invoked on an idle VM, the pages generally have to be decompressed before starting the actual execution of the FaaS function. This is referred to as warm start or warm boot (a cold start or cold boot is when a new VM instance is freshly booted).

To accelerate memory (de)compression, a hardware accelerator for compression and decompression may be used. Even though such a compression/decompression hardware accelerator is fast, decompressing a VM's page on-demand (at the time of page fault) may incur a high latency due to software overhead (mainly in the Operating System, OS), such as looking up the compressed data in ZSWAP and finding a free memory page to save the decompressed data. Such high latencies for data decompression may decrease the performance.

### BRIEF DESCRIPTION OF THE FIGURES

Some examples of apparatuses and/or methods will be described in the following by way of example only, and with reference to the accompanying figures, in which

FIG. 1a shows a schematic diagram of an example of an apparatus or device for managing memory, and of a computer system comprising such an apparatus or device and the memory;

FIG. 1b shows a flow chart of an example of a method for managing memory;

FIGS. 2a and 2b show diagrams of sequences of page faults for two different instances of warm starts;

FIG. 3 shows a schematic diagram of an example implementation of ahead of time prefetching on Linux with ZSWAP; and

FIG. 4 shows a schematic diagram of an example implementation of prefetch on invocation on Linux with ZSWAP.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

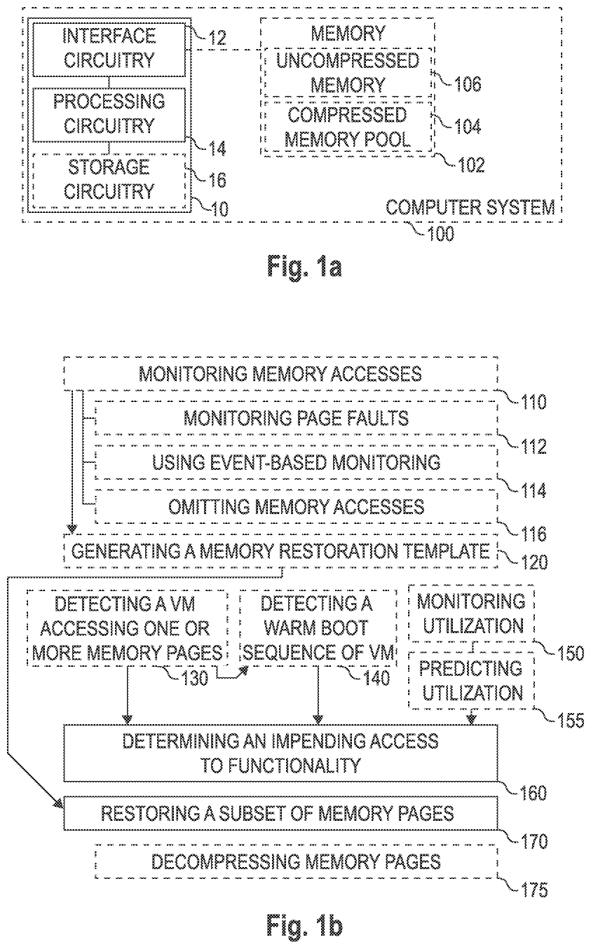

FIG. 1a shows a schematic diagram of an example of an apparatus 10 or device 10 for managing memory 102, and of a computer system 100 comprising such an apparatus 10 or device 10 and the memory 102. The apparatus 10 comprises circuitry to provide the functionality of the apparatus 10. For example, the circuitry of the apparatus 10 may be configured to provide the functionality of the apparatus 10. For example, the apparatus 10 of FIGS. 1a and 1b comprises interface circuitry 12, processing circuitry 14 and (optional) storage circuitry 16. For example, the processing circuitry 14 may be coupled with the interface circuitry 12 and with the storage circuitry 16. For example, the processing circuitry 14 may provide the functionality of the apparatus, in conjunction with the interface circuitry 12 (for exchanging information, e.g., with other components inside or outside the computer system 100 comprising the apparatus or device 10, such as the memory 102) and the storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIGS. 1a and 1b comprises means for processing 14, which may correspond to or be implemented by the processing circuitry 14, means for communicating 12, which may correspond to or be implemented by the interface circuitry 12, and (optional) means for storing information 16, which may correspond to or be implemented by the storage circuitry 16. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The apparatus 10 or device 10 may comprise the machine-readable instructions, e.g., within the storage circuitry 16 or means for storing information 16.

The processing circuitry 14 or means for processing 14 is to determine an impending access to a functionality provided by a virtual machine. The processing circuitry 14 or means for processing 14 is to restore a subset of memory pages associated with the virtual machine from a compressed memory pool 104 to uncompressed memory 106 according to a memory restoration template after determining the impending access to the virtual machine.

FIG. 1b shows a flow chart of an example of a corresponding method for managing memory. The method comprises determining 160 the impending access to a functionality provided by a virtual machine. The method comprises restoring 170 the subset of memory pages associated with the virtual machine from the compressed memory pool to uncompressed memory according to the memory restoration template after determining the impending access to the virtual machine. For example, the method may be performed by the computer system 100 comprising the memory 102, e.g., by the apparatus 10 or device 10 of the computer system 100. In FIG. 1b, and other figures of the present disclosure, dashed or dotted lines may indicate optional features.

In the following, the functionality of the apparatus 10, the device 10, the method and of a corresponding computer program is illustrated with respect to the apparatus 10. Features introduced in connection with the apparatus 10 may likewise be included in the corresponding device 10, method and computer program.

The present disclosure relates to a concept for restoring memory of a virtual machine from a compressed memory pool to uncompressed memory. Such functionality is used in computer systems that are used for providing one or more functionalities as Function as a Service (FaaS). Accordingly, the functionality provided by the virtual machine may be a Function as a Service (FaaS) provided by the virtual machine.

FaaS is a concept, where a functionality (i.e., the “function” in FaaS) are provided in isolation by a cloud server. The functionality being provided may be a data processing functionality, e.g., based on business logic, based on an algorithm, a machine-learning model etc., and usually provides output data in response to input data. This functionality is implemented by virtual machines, which are hosted by a host computer system (such as the computer system 100). In general, FaaS providers do not only host one instance of such a FaaS VM on the same server (i.e., the computer system), but many instances at the same time. In other words, the virtual machine may be one of a plurality of virtual machines providing the functionality being hosted by a computer system. At the same time, a server may host different VMs for providing different functionalities as FaaS.

The number of FaaS VMs providing the same functionality running at the same time determines the number of concurrent accesses to the functionality possible, with the FaaS provider being able to scale the number of running VMs providing the functionality up and down, depending on the number of concurrent requests. Such scaling is possible as the functionality provided does not rely on persistent data being stored in the respective VM. To allow for fast scaling of running VMs, FaaS providers generally try to avoid cold-booting the VMs (i.e., booting the VMs without restoring a stored memory snapshot). Instead, if a VM is scaled down, the VM may be transitioned from an active state (where the VM is operable to provide the functionality) to an idle state. In other words, to scale the number of active VMs down, the processing circuitry may transition one or more VMs from the active state to the idle state.

In the idle state, the memory pages associated with the VM, as well as memory pages of the virtualization software process, may be moved from uncompressed memory to a compressed memory pool, such as ZSWAP or Active Memory Expansion by IBM®. ZSWAP is a kernel feature of the Linux kernel which allows for storing swapped out memory pages in a compressed memory pool, i.e., a memory region of the memory for storing memory pages in compressed from. When the memory pages are swapped out, the content of the memory pages is compressed and stored within the compressed memory pool. Accordingly, the processing circuitry may swap out the memory pages of a virtual machine after (or as part of) transitioning the virtual machine to the idle state. When the memory pages are swapped in, the compressed content of the memory pages is decompressed again and copied to uncompressed memory (i.e., a memory region of the memory where uncompressed memory pages are stored). The swapping in of the memory pages is generally triggered by a page fault, which may, in the present context, occur when a virtual machine is transitioned form the idle state to the active state again. In other words, when the processing circuitry transitions the virtual machine from the idle state to the active state, page faults occur as the virtual machine starts operating again. Unfortunately, these page faults are costly, as they are handled one-by-one, as they occur, with a large software overhead for decompressing the data and finding an empty page in uncompressed memory, with additional overhead being caused by a context switch.

The present disclosure addresses this overhead using the aforementioned memory restoration template. Instead of handling the page faults one by one, the present concept uses the memory restoration template to restore multiple memory pages of the virtual machine from the compressed memory pool to uncompressed memory at once, sidestepping the overhead caused by the individual page faults. Moreover, instead of restoring all of the memory pages associated with a virtual machine, the present concept merely restores a subset of the memory pages. In particular, heuristics may be used to identify memory pages that are likely used at every use of the virtual machine, in contrast to memory pages that are never used or that are used for infrequent (housekeeping) tasks.

The starting point of the proposed concept is the memory restoration template. In general terms, the memory restoration template defines the subset of memory pages to be restored from the compressed memory pool to the uncompressed memory. For example, the memory restoration template may comprise information on virtual addresses of the memory pages to be restored from the compressed memory pool to the uncompressed memory. These memory pages (i.e., their virtual addresses) may initially be recorded to the memory restoration template. The recordation of the memory restoration template may be performed by the apparatus 10, or it may be performed by another apparatus of another computer system. In general, cloud service providers manage a multitude of servers hosting VMs for providing the same functionality. Memory restoration templates recorded on one of the servers may be transferred to the other servers as well.

In the following, examples are given on how the memory restoration template can be created, by the apparatus or by another apparatus of another server. Since the memory restoration template represents the subset of memory pages to be restored, this subset of memory pages may be determined by monitoring the memory access pattern of one or more warm boots of the virtual machine. Accordingly, the memory restoration template may be based on monitored memory accesses of at least one of the virtual machine, an equivalent virtual machine (being hosted on the same computer system or another computer system), and a hypervisor (of the computer system or another computer system). In particular, the memory restoration template may define memory pages both of the VMs guest memory as well as memory pages from the hypervisor (i.e., the virtualization software hosting the VM on the computer or on another computer). In other words, the subset of memory pages may comprise at least one of memory pages associated with state information of a hypervisor, with the state information being associated with the virtual machine, and memory pages being allocated to the virtual machine.

In the following, the procedure for recording the memory accesses by the processing circuitry is described. For example, the processing circuitry may monitor memory accesses of at least one of the virtual machine, the equivalent virtual machine, and the hypervisor, and generate the memory restoration template based on the monitored memory accesses. Accordingly, as further shown in FIG. 1b, the method may comprise monitoring 110 memory accesses of at least one of the virtual machine, the equivalent virtual machine, and the hypervisor, and generating 120 the memory restoration template based on the monitored memory accesses. In general, the memory accesses may be monitored using various ways. In various examples, page faults relating to pages in the compressed memory pool may be recorded, using tools such as perf or ftrace. In other words, the processing circuitry may monitor page faults to monitor the memory accesses. Accordingly, as further shown in FIG. 1b, the method may comprise monitoring 112 page faults to monitor the memory accesses. Alternatively, a functionality supported by some modern processors may be used. In some processors, an event-based monitoring functionality may be configured, e.g., by the processing circuitry, to record accesses to memory pages in the compressed memory pool. The event-based monitoring functionality may then store a log of the memory access to memory pages in the compressed memory pool in a buffer, which may then be used by the processing circuitry to monitor the memory accesses. Thus, the processing circuitry may use an event-based monitoring functionality of a processor being used to execute the virtual machine or equivalent virtual machine to monitor the memory accesses. Accordingly, as further shown in FIG. 1b, the method comprises using 114 an event-based monitoring functionality of a processor being used to execute the virtual machine or equivalent virtual machine to monitor the memory accesses. Both the page-fault monitoring and the event-based monitoring may be performed when an (equivalent) VM providing the functionality is transitioned from the idle state to the active state.

While the present concept is already feasible with a one-time monitoring of the memory accesses, the quality of the memory restoration template may be improved by monitoring the memory accesses across multiple warm boots and generating the memory restoration template for memory accesses that occur across different warm boots, as these are the memory accesses that are likely to occur in each warm boot of the VM. For example, the processing circuitry may monitor the memory accesses across a plurality of warm boot sequences of the virtual machine or equivalent virtual machine, and to generate the memory restoration template based on the monitored memory accesses occurring across the plurality of warm boot sequences. Accordingly, the method may comprise monitoring 110 the memory accesses across a plurality of warm boot sequences of the virtual machine or equivalent virtual machine and generating 120 the memory restoration template based on the monitored memory accesses occurring across the plurality of warm boot sequences. Memory accesses that occur non-consistently (i.e., not in every warm boot sequences, e.g., at in most 50% of warm boot sequences) may be omitted from the memory restoration template, and thus from the subset of memory pages. In other words, the processing circuitry may omit (i.e., not include or remove) memory accesses from the generation of the memory restoration template that occur non-consistently across the plurality of warm boot sequences. Accordingly, as further shown in FIG. 1b, the method may comprise omitting 116 memory accesses from the generation of the memory restoration template that occur non-consistently across the plurality of warm boot sequences.

In the above examples, the memory pages are omitted by comparing the memory accesses across the different warm boots. Additionally, or alternatively, additional techniques may be used to determine memory accesses to be omitted. For example, artificial intelligence/machine-learning may be used to identify memory accesses to be omitted. For example, anomaly detection (i.e., outlier detection) may be used, which is aimed at providing an identification of input values that raise suspicions by differing significantly from the majority of input or training data. In other words, the processing circuitry may use a machine-learning model to identify memory accesses to be omitted, with the machine-learning model being at least partially trained to perform anomaly detection, and/or the machine-learning algorithm may comprise an anomaly detection component. For example, the machine-learning model may be trained, using supervised learning, with training samples labeled as “normal” samples (i.e., for memory accesses to be included in the memory restoration template) and labeled “anomalous” samples (for memory accesses to be omitted). For example, the training samples may represent the number of times across multiple warm boots a memory page has been accessed. Accordingly, the monitored memory accesses across warm boots may be accumulated and summed up and, and the sums of memory accesses may be used as input for the machine-learning model to determine the memory accesses to be omitted.

To generate the memory restoration template, information on the memory pages (such as the virtual memory addresses) being monitored (and not omitted) may be stored in a buffer, e.g., in a per-VM buffer. When the operating system, on top of which the hypervisor is run, is the Linux operating system, the memory restoration template may be stored in the per-VM buffer via the /proc/<process_id_of_the_virtualization_software_hosting_the_VM> interface. In some examples, the processing circuitry might not only monitor the memory accesses, but also the order of the memory accesses. In this case, the memory restoration template might not only contain the information on the subset of memory pages (i.e., the virtual addresses of the subset of memory pages), but also information on an order in which the subset of memory pages (i.e., the memory pages at the virtual memory addresses) are to be restored. This is particularly beneficial if the memory pages are prefetched on invocation

In an alternative example, the processing circuitry may perform merely the features related to the generation of the memory restoration template, e.g., the monitoring of the memory accesses (via page faults or event-based monitoring), the omitting of memory accesses, and the generating of the memory restoration template. In some examples, the processing circuitry may do both—generating and using the memory restoration template, and in some examples, the processing circuitry might only use the memory restoration template being generated by another apparatus or computer system.

In the following, the usage of the memory restoration template is detailed. In the present context, the usage of the memory restoration template is triggered by the detection of an impending access to the functionality provided by the virtual machine. In this context, the “impending access” can mean a) an access that is about to happen in the near future (e.g., within the next 600 seconds, within the next 300 seconds, within the next 120 seconds, within the next 60 seconds, or within the next 30 seconds) and b) an access that is currently being requested. In other words, the term “impending access” may mean that the access is about to happen or that the access has already been requested. In both cases, the impending access is associated with a warm boot of the virtual machine. In other words, determining the impending access may correspond to determining an impending warm boot (i.e., transition from the idle state to the active state) of the virtual machine, i.e., a warm boot that is already occurring or that is about to happen in the near future (e.g., within the next 600 seconds, within the next 300 seconds, within the next 120 seconds, within the next 60 seconds, or within the next 30 seconds).

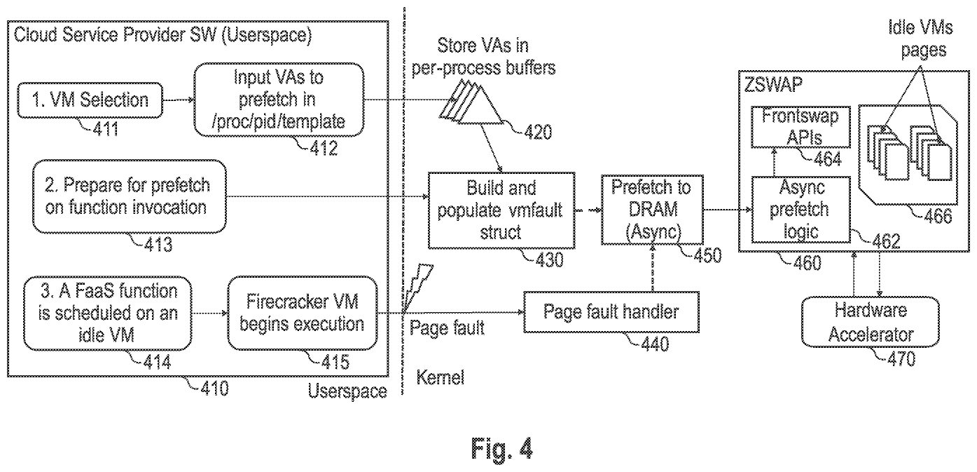

In a basic implementation, which is, in connection with FIG. 4, denoted prefetch on invocation or on-fault prefetching, the determination of the impending access to the functionality (i.e., warm boot of the virtual machine) correspond to the determination of an access that is already requested, i.e., a warm boot that is already being performed. When a warm boot is being performed, the virtual machine tries to access the subset of memory pages while they are still stored in the compressed memory pool. Therefore, an access to the subset of memory pages while they are still in the compressed memory pool may indicate the impending access to the functionality, i.e., the warm boot of the virtual machine. Thus, the processing circuitry may detect the virtual machine accessing one or more of the memory pages (of the subset of memory pages) while the one or more memory pages are stored in the compressed memory pool, and to determine the impending access to the functionality provided by the virtual machine based on the detected access to the one or more memory pages. Accordingly, as further shown in FIG. 1b, the method may comprise detecting 130 the virtual machine accessing one or more of the memory pages while the one or more memory pages are stored in the compressed memory pool and determining 160 the impending access to the functionality provided by the virtual machine based on the detected access to the one or more memory pages. Similar to the monitoring of the memory accesses being performed for the generation of the memory restoration template, both page faults and the event-based monitoring functionality may be used to detect the virtual machine accessing one or more of the memory pages. In other words, the processing circuitry may detect the virtual machine accessing one or more of the memory pages while the one or more memory pages are stored in the compressed memory pool based on one or more page faults resulting from the access. Accordingly, the method may comprise detecting 130 the virtual machine accessing one or more of the memory pages while the one or more memory pages are stored in the compressed memory pool based on one or more page faults resulting from the access. Alternatively, the event-based monitoring functionality may be used to detect the virtual machine accessing one or more of the memory pages.

As outlined above, the virtual machine accessing the subset of memory pages while they are stored in the compressed memory pool usually means that the virtual machine is being warm-booted. For example, the processing circuitry may detect a warm boot sequence of the virtual machine (e.g., based on the virtual machine accessing the one or more memory pages while they are stored in the compressed memory pool, or based on a signal from the hypervisor or orchestration software), and determine the impending access to the functionality provided by the virtual machine and restore the subset of memory pages based on the detection of the warm boot sequence. Accordingly, as further shown in FIG. 1b, the method may comprise detecting 140 a warm boot sequence of the virtual machine and determining 160 the impending access to the functionality provided by the virtual machine and restore the subset of memory pages based on the detection of the warm boot sequence.

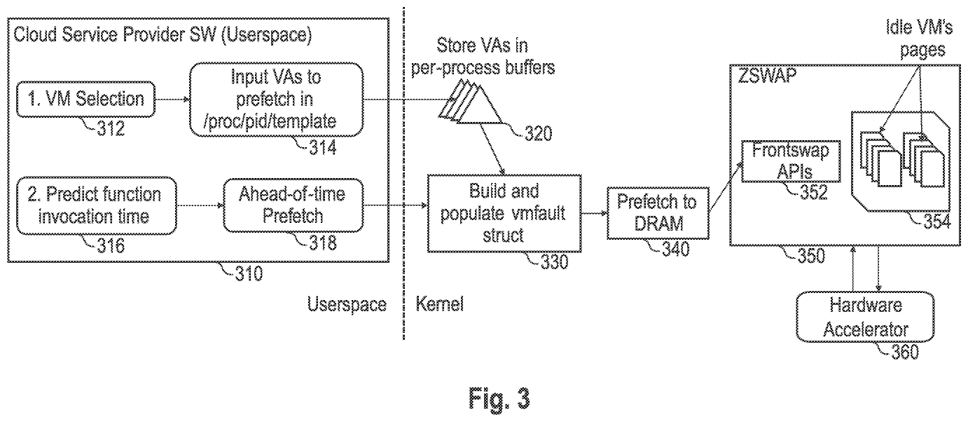

The above concept (prefetch on invocation) has the drawback that the impending access is detected as the virtual machine is already warm-booting, resulting in some page faults at the beginning of the restoration of the subset of memory pages. While the actual restoration may then continue asynchronously and/or in the order that the memory pages are likely being accessed, the initial page faults may result in additional delays. To avoid such delays, the memory restoration may be triggered, and therefore also performed, before the warm-boot (i.e., the transition from idle to active) occurs. In other words, a predictive approach may be used, which is denoted ahead of time prefetching in connection with FIG. 3. In general, the load of servers of cloud service providers is somewhat predictable. Time-series data of accesses to the functionality may be kept and used to forecast (using time-series forecasting, which is also known as time-series projection) accesses to the functionality in the future. If an increase in utilization is predicted, an impending access to the functionality may be determined and the subset of memory pages of the VM may be restored before the VM is returned to the active state. For example, the virtual machine may be one of a plurality of virtual machines being hosted by a computer system, each of the virtual machines hosting the functionality, i.e., one of many VMs providing the same functionality being hosted by the server. The processing circuitry may monitor a utilization of the functionality being provided by the plurality of virtual machines over time (i.e., the processing circuitry may generate a time-series of the utilization, i.e., the accesses to the functionality). The processing circuitry may determine the impending access to the functionality provided by the virtual machine and restore the subset of memory pages based on the monitored utilization of the plurality of virtual machines over time. Accordingly, as further shown in FIG. 1b, the method may comprise monitoring 150 a utilization of the functionality being provided by the plurality of virtual machines over time and determining 160 the impending access to the functionality provided by the virtual machine and restore the subset of memory pages based on the monitored utilization of the plurality of virtual machines over time. In particular, the monitored utilization may be used to predict the utilization of the functionality in the future, e.g., using time-series forecasting/time-series projection. Thus, the processing circuitry may predict the utilization of the functionality in the future based on the monitored utilization of the plurality of virtual machines over time and determine the impending access to the functionality provided by the virtual machine and restore the subset of memory pages based on the predicted utilization in the future. Accordingly, as further shown in FIG. 1b, the method comprises predicting 155 the utilization of the functionality in the future based on the monitored utilization of the plurality of virtual machines over time and determining 160 the impending access to the functionality provided by the virtual machine and restore the subset of memory pages based on the predicted utilization in the future. For example, if the predicted utilization of the functionality in the future is larger than the current utilization of the functionality, an impending access to the functionality by the VM (which is currently idle) may be determined, as the VM is likely to be warm-booted shortly. In addition, prefetch on invocation (i.e., on-fault prefetching) may be used as fallback for warm boots not being predicted.

After an impending access has been determined (e.g., triggered by, or in response to, the determination of the impending access), the restoration of the subset of memory pages is being performed according to the memory restoration template. For example, the kernel of the operating system of the computer system may use the memory restoration template to restore the subset of memory pages to uncompressed memory, e.g., foregoing/preempting page faults for subsequent accesses to these memory pages by the virtual machine or hypervisor. For example, if the memory restoration template defines an order, in which the memory pages are to be restored, the restoration may be performed according to the order defined by the memory restoration template. In contrast to other concepts, in the present context, only some of the memory pages (i.e., the subset) associated with the virtual machine may be restored, while some other memory pages may remain in the compressed memory pool. In other words, at least one memory page associated with the virtual machine may be omitted from restoration according to the memory restoration template.

In the present concept, the memory pages are restored from the compressed memory pool to the uncompressed memory. Therefore, the restoration may also involve decompressing the memory pages. In other words, restoring the subset of memory pages may comprise decompressing the memory pages. Accordingly, as further shown in FIG. 1b, restoring 170 the subset of memory pages may comprise decompressing 175 the memory pages. This decompression, and other parts of the restoration, may be sped up by a hardware accelerator, e.g., a memory operation hardware accelerator, which may be part of the central processing unit (CPU, i.e., the processor) of the computer system. For example, the processing circuitry may decompress at least some memory pages the subset of memory pages using a hardware-based decompression functionality (i.e., the hardware accelerator) of a processor being used to execute the virtual machine. Accordingly, the method may comprise decompressing 175 at least some memory pages the subset of memory pages using a hardware-based decompression functionality of a processor being used to execute the virtual machine. For example, the hardware-based decompression functionality may be instructed by the processing circuitry and/or the kernel of the operating system to restore the subset of memory pages.

The present computer system comprises memory 102, which comprises both the uncompressed memory pool 104 and the uncompressed memory 106, as shown in FIG. 1b. For example, the memory 102 may be random access memory, such as dynamic random-access memory (DRAM), e.g., DRAM being part of a Dual Inline Memory Module (DIMM) or DRAM being part of High Bandwidth Memory. Alternatively, the memory 102 may be persistent memory, e.g., persistent memory being part of a DIMM.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be a server computer system, i.e., a computer system being used to serve functionality, such as functionality provided by the virtual machine, to one or more client computers.

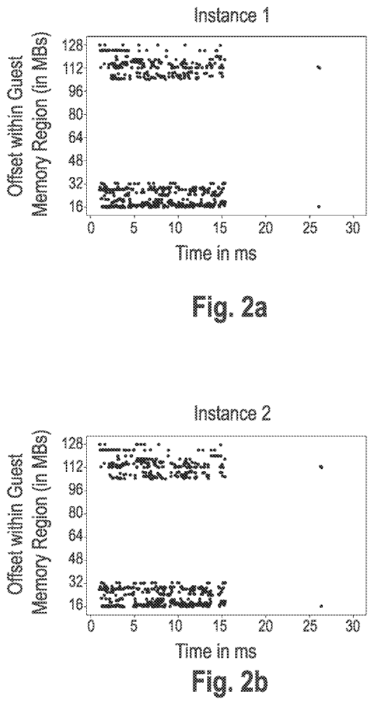

More details and aspects of the apparatus 10, device 10, method, computer program and computer system 100 are mentioned in connection with the proposed concept, or one or more examples described above or below (e.g., FIGS. 2a to 4). The apparatus 10, device 10, method, computer program and computer system 100 may comprise one or more additional optional features corresponding to one or more aspects of the proposed concept, or one or more examples described above or below.

Various examples of the present disclosure relate to a concept for speeding up FaaS (Function as a Service) warm starts by prefetching compressed pages with learnt page fault templates.

To reduce software overheads from critical page fault path during warm start, a concept is proposed in which pages are protected from a compressed memory pool (such as ZSWAP).

The proposed concept is based on the finding that thousands of ZSWAP page faults may be incurred when a VM warm starts, and that the sequence of page faults incurred is often similar across multiple warm start instances. In the proposed concept, the sequence of virtual addresses that incur page faults may be recorded in a (memory restoration) template. Those pages (as recorded in the template) may be prefetched from ZSWAP. Such prefetching may eliminate costly page faults inside a VM and thus reduce warm start time.

In some other systems, other types of prefetching is used. One known type of prefetching is denoted “sequential/stride prefetching”, which is a type of prefetching that prefetches adjacent pages from the faulting address. For example, upon a page fault on virtual address X in ZSWAP, sequential prefetching prefetches X+1, X+2 up to X+n. This type of prefetching works best for compute intensive workloads which exhibit data access patterns. For example, during matrix multiplication, pages backing the next few rows/columns from the current index can be prefetched from a compressed memory pool. However, FaaS workloads do not exhibit such patterns that depend on the pages touched by the guest operating system

In some other systems, snapshots may be used to speed up warm boots of VMs. Snapshots may reduce memory utilization in the system by snapshotting the running instance of the VM to disk, thus freeing up DRAM (Dynamic Random Access Memory). Upon a function execution request, a new VM instance may be cloned from the snapshot. However, there are some limitations with snapshotting: For example, not all VM instances can be snapshotted because network and socket status are not preserved during the snapshot. Moreover, snapshots may have security implication as a new VM is cloned from the snapshot to run a FaaS function, which results in an identical state for random number generators (i.e., poor entropy). Such issues do not arise in the proposed concept, as the live instance of the VM is retained, but with pages pushed to the compressed memory pool.

A major aspect of the proposed concept may be to reduce the software overhead in a FaaS environment during a VM warm start from a compressed memory pool by generating a template from the learnt sequence of virtual addresses that incur page faults during VM warm start. The sequence of pages from compressed memory pools, such as ZSWAP, may be prefetched to DRAM using the page fault template either during or before a FaaS function invocation request. With prefetching, costly page faults incurred by a VM during warm start and the corresponding guest to host context switches may be eliminated or reduced, thus reducing VM warm start time and FaaS function execution latency. As a result, Cloud Service Providers (CSPs) can aggressively push idle VMs to a compressed memory pool to reduce TCO (Total Cost of Ownership) and to improve VM density per GB of memory. The proposed concept may both improve the performance and VM density. A CSP can improve VM warm start time while also packing more VMs per gigabytes of memory. The proposed concept may increase the total addressable market for CPU manufacturers, as less memory is required. The proposed concept may further benefit from hardware accelerators for compressing and decompressing data in memory—while the concept can be used without such a hardware accelerator, it may be more efficient to use such a hardware accelerator. Such hardware accelerators may thus reduce the memory TCO, as less memory is required.

In multi-tenure FaaS environments a typical function is executed inside a lightweight VM such as Firecracker or Gvisor for better security and isolation. Upon a new user request, a Cloud Service Provider (CSP) checks if there are any active VMs for the corresponding user. If so, the CSP assigns the request to one such VM (hot start). If an active VM is not available, then an “idle” VM may be “warm started” from a compressed memory pool. In cases when an “idle” VM is also not available, a new VM instance may be booted (cold start) to serve the request. If a VM is idle for a threshold period of time due to no new user request, its pages may be moved into compressed memory pool (e.g., ZSWAP). Compressing idle VM's pages is important with respect to the economics of the cloud, as idle VMs still consume memory. In typical FaaS environments, moving the pages of a VM to compressed memory pool and bringing them back to DRAM by decompressing are critical and frequently triggered operations. Therefore, it may be beneficial to improve these operations.

In general, during warm start, the idle VM's pages may be decompressed on demand, i.e., (only) when the VM page faults on a page in ZSWAP. Upon a page fault, the data corresponding to the faulting virtual address may be decompressed from ZSWAP and placed in (uncompressed) DRAM memory. However, on-demand moving of pages from ZSWAP to DRAM generally incurs high overheads as a new page is allocated in DRAM and the contents in ZSWAP are decompressed and moved to DRAM. In addition, a context switch from guest to host (which includes costly VM exits) also add to the overhead. Overall, on-demand page faults contribute to the average and tail function call latency in FaaS environments.

A memory compression/decompression hardware accelerator does not completely solve the warm start overhead, as an operating system's page management activities such as finding and allocating a free page to place the decompressed data, may take up a significant amount of CPU cycles.

FIGS. 2a and 2b show diagrams of sequences of page faults for two different instances of warm starts. FIGS. 2a and 2b may depict the sequence of pages faults in a VM's memory region for two different instances of warm start as observed from the host. As is evident from the diagrams, more than 98% of the pages retrieved across warm starts remain the same. Thus, it can be deduced that the sequence of virtual addresses that incur page faults during warm start is similar across multiple warm start instances of the same VM. Based on this observation, a page fault template (i.e., the memory restoration template) may be created by recording the sequence of faults by profiling the warm start of a VM instance and prefetching the sequence of pages from ZSWAP to DRAM using the page fault template to reduce VM warm start time.

In the following, an example of an algorithm to generate and use a fault template is shown. In a first stage, an idle VM instance whose pages are compressed and placed in ZSWAP may be picked (i.e., selected) to generate the page fault template. In a second stage, the sequence of faulting virtual addresses may be recorded in a template from the host context when the VM warm starts for the first time. The page faults may include pages belonging to the guest VM's physical memory (which is memory mapped into a process of a virtualization software, such as QEMU) as well as the heap and stack pages of the virtualization software process. The pages belonging to virtualization software process may be the vCPU and device states that the virtualization software maintains to enable virtualization.

In a third stage, the second stage may be performed multiple times to capture the sequence of virtual address that page faults across multiple warm starts. It is possible that some page faults are triggered due to housekeeping/background activities inside the guest VM, such as the pages accessed by daemons inside the VM. Such pages might not be in the critical path of FaaS function execution and thus might not need to be included (i.e., they may be omitted) in the template.

In a fourth stage, optional additional processing may be performed on the captured virtual address sequences across multiple iterations. For example, the generated sequence can be filtered or hardened using AI/ML (Artificial Intelligence/Machine Learning) techniques. This may eliminate pages accessed by housekeeping/background tasks inside the guest VM. These pages that are eliminated (i.e., omitted) from the template are not-prefetched but may be fetched on-demand.

In a fifth stage, the template, which may comprise or consist of a set of virtual addresses of the virtualization software process, may be input to the host kernel, e.g., defining interfaces in /proc/<virtualization_software_pid>/ directory. The host kernel may store the template in a per-process buffer.

In a sixth stage, prefetching of pages in ZSWAP (or any other compressed memory pool) may be enabled using the template for the selected VM instance. An enhanced host OS kernel may receive actions (i.e., instructions) from user space cloud management software on when to perform the prefetching (e.g., upon an impending access to the functionality).

In a seventh stage, the host kernel may prefetch the pages from ZSWAP as instructed by the cloud management software and update the page table entries accordingly. The pages that are prefetched may include the guest kernel and guest user space pages as well as the heap and stack pages of the virtualization software process (for example, pages for vCPU and register states allocated and maintained by the virtualization software process). The guest kernel pages may include pages containing guest kernel data structures, and the guest user space pages may include pages belonging to runtimes (e.g., Python, Java, Go, etc.,) that are used for FaaS function execution.

In an eight stage, during a FaaS function execution, when a VM accesses the virtual address that is prefetched, the CPU might not incur a page fault but may simply performs a hardware page table walk to update the TLB entries, thus eliminating costly VM exits. In addition, if the virtualization software stack and heap pages are prefetched, latencies incurred to decompress these pages may be reduced or eliminated.

In the following, two different potential prefetch implementations are shown. Two ways to prefetch are proposed, one is ahead-of-time prefetching and the other in prefetch on FaaS function invocation.

In ahead of time prefetching, the host kernel prefetches the pages from ZSWAP using the template, even when the VM is “idle”. Ahead of time prefetching may be done based on characterization data of the respective cloud environment (e.g., as described Shahrad et. al., “Serverless in the Wild: Characterizing and Optimizing the Serverless Workload at a Large Cloud Provider”, USENIX ATC '20). For example, some cloud environments use time-series analysis to predict VM invocation patterns, i.e., for a significant set of functions they can predict the next invocation time. This prediction infrastructure can be exploited by prefetching the pages from ZSWAP well before a function execution request is triggered.

FIG. 3 shows a schematic diagram of an example implementation of ahead of time prefetching on Linux with ZSWAP. FIG. 3 distinguishes between userspace and kernel. In userspace, the cloud service provider software 310 comprises a VM selection block 312, which may input 314 the virtual addresses to prefetch into /proc/pid/template. The cloud service provider software 310 comprises a predict function invocation time block 316, which triggers the ahead-of-time prefetch 318. In the kernel, the virtual addresses are stored 320 in per-process buffers. The kernel may build and populate 330 a vmfault (virtual memory fault) struct and trigger a prefetch to DRAM block 340. In ZSWAP 350, the frontswap APIs (Application Programming Interfaces) 352 may be used to prefetch the idle VMs pages 354, e.g., using hardware accelerator 360.

For example, a cloud management software such as Kubernetes may monitor the VM instances that are idle for a threshold amount of time and push the entire VM (which is the virtualization software process from the host point of view) to the compressed ZSWAP pool. Upon a FaaS function invocation request on an idle VM pushed into ZSWAP, the cloud management software may select 312 and VM and monitor and record the page faults in ZSWAP, e.g., using tools such as perf/ftrace. The page faults may be recorded, and the template may be generated as mentioned in the above algorithm. The cloud management software may input 314 the template, which may be a set of virtual addresses, via the /proc/<virtualization_software_pid> interface (in case of Linux/BSD/Unix systems). The kernel may store 320 these virtual addresses in a per-process buffer. Based on the time-series analysis data available with cloud service providers, the FaaS function invocation time may be accurately predicted 316 by the cloud management software. Using this data, the cloud management software may instruct 318 the OS kernel to prefetch the pages that are in the template. Thus, the required working set of pages of the VM may be decompressed and prefetched from ZSWAP to DRAM ahead of time.

It should be noted that, without templates, prefetching the entire VM from ZSWAP wastes crucial systems resources such as CPU cycles and memory bandwidth as many of these pages are never accessed. With page fault templates, a small set of pages that are absolutely required to warm start the VM may be prefetched, while the rest of the pages may be fetched on-demand from ZSWAP. Experiments reveal that for single Firecracker VM instance, a warm start requires prefetching only around 10 MB from ZSWAP out of the total memory footprint of 130 MB. The remaining 120 MB of data may remain compressed and may be kept in ZSWAP, resulting in memory TCO savings.

In the following, the “prefetch on invocation” implementation is shown. In many cases, not all function invocations can be predicted. In these cases, pages from ZSWAP might not be fetched before the execution request is triggered. Therefore, the host kernel may prefetch the page upon the function invocation. As soon as the VM is scheduled to run, the pages may be prefetched from ZSWAP using the template. To ensure prefetching does not interfere with VM execution, pages can be prefetched asynchronously in the background.

FIG. 4 shows a schematic diagram of an example implementation of prefetch on invocation (also called on-fault prefetching) on Linux with ZSWAP. Prefetch on invocation is similar to ahead-of-time prefetching for generating the template. VM selection 411 may be performed, followed by inputting the virtual addresses to prefetch in /proc/pid/template. The kernel may then store the virtual addresses in per-process buffers 420. This may be followed by a trigger, by the cloud service provider software 410, to prepare 413 for prefetching on function invocation, which may trigger the building and population 430 of the vm_fault struct. For FaaS functions for which the cloud management software cannot predict the invocation time, the OS kernel may be instructed to prefetch pages from ZSWAP using the template whenever the VM or the virtualization software process first faults on ZSWAP. Upon the first fault in ZSWAP, i.e., when a FaaS function is scheduled 414 on an idle VM and the Firecracker VM begins execution 415, triggering page fault handler 440, the OS may decompress and prefetch 450 (all) the pages in the template from ZSWAP (e.g., asynchronously). In this case, the first page accessed by the VM may results in a page fault on ZSWAP and thus incur the decompression overheads while the subsequent pages accessed might not result in a page fault as they are asynchronously prefetched after the first fault.

In the following, the proposed concept is differentiated from other prefetching concepts. In particular, what is captured and prefetched in a template and the context in which prefetching is applied is different from other prefetching concepts.

To generate the template, the proposed concept may record page faults on ZSWAP. In some cases, one-time profiling of page faults might not be considered enough as the proposed concept deals with live VMs. Multiple profiling may be used with additional filtering or processing to generate the template. In contrast, in file readahead (in which the contents of a file is prefetched), a pattern of page accesses of an application within a file are recorded. In snapshot-based prefetching, page faults in the file offset of the snapshot may be recorded, and a one-time recording of page faults in the snapshot file may be performed.

In the proposed concept, the FaaS prefetch target is a live VM instance. In snapshot-based prefetching, a newly forked VM instance is the FaaS prefetch target. File readahead, on the other hand, is a generic prefetching technique, which is not specific to FaaS environments.

When a live VM instance transitions (or is likely to transition) from an idle state to an active state, the prefetch is triggered in the proposed concept. In contrast, file readahead may be performed when an application reads/writes to the file. Snapshot-based prefetching is triggered when a new VM instance is initialized from a snapshot.

In the proposed concept, the live VM state (includes guest memory) as well as stack and heap of the virtualization software process are prefetched. When performing a file readahead, the content of a (single) file are prefetched. In snapshot-based prefetching, the saved VM state in the snapshot file (includes only the guest memory) is prefetched.

The prefetch concepts also differ with respect to the prefetch operation. In the proposed concept, pages are decompressed from a compressed memory pool, such as ZSWAP, to DRAM. When a file readahead is performed, data is loaded from disk/solid-state drive to DRAM. Similarly, in snapshot-based prefetching, data is loaded from disk/solid-state drive to DRAM.

More details and aspects of the concept for speeding up FaaS warm starts by prefetching compressed pages with learnt page fault templates are mentioned in connection with the proposed concept or one or more examples described above or below (e.g., FIG. 1a to 1b). The concept for speeding up FaaS warm starts by prefetching compressed pages with learnt page fault templates may comprise one or more additional optional features corresponding to one or more aspects of the proposed concept, or one or more examples described above or below.

In the following, some examples of the proposed concept are presented:

An example (e.g., example 1) relates to an apparatus (10) for managing memory (102), the apparatus comprising interface circuitry (12) and processing circuitry (14) to determine an impending access to a functionality provided by a virtual machine, and to restore a subset of memory pages associated with the virtual machine from a compressed memory pool to uncompressed memory according to a memory restoration template after determining the impending access to the virtual machine.

Another example (e.g., example 2) relates to a previously described example (e.g., example 1) or to any of the examples described herein, further comprising that the functionality provided by the virtual machine is a Function as a Service (FaaS) provided by the virtual machine.

Another example (e.g., example 3) relates to a previously described example (e.g., one of the examples 1 to 2) or to any of the examples described herein, further comprising that the virtual machine is one of a plurality of virtual machines providing the functionality being hosted by a computer system.

Another example (e.g., example 4) relates to a previously described example (e.g., one of the examples 1 to 3) or to any of the examples described herein, further comprising that the memory restoration template defines the subset of memory pages to be restored from the compressed memory pool to the uncompressed memory.

Another example (e.g., example 5) relates to a previously described example (e.g., example 4) or to any of the examples described herein, further comprising that at least one memory page associated with the virtual machine is omitted from restoration according to the memory restoration template.

Another example (e.g., example 6) relates to a previously described example (e.g., one of the examples 4 to 5) or to any of the examples described herein, further comprising that the memory restoration template is based on monitored memory accesses of at least one of the virtual machine, an equivalent virtual machine, and a hypervisor.

Another example (e.g., example 7) relates to a previously described example (e.g., example 6) or to any of the examples described herein, further comprising that the processing circuitry is to monitor memory accesses of at least one of the virtual machine, the equivalent virtual machine, and the hypervisor, and to generate the memory restoration template based on the monitored memory accesses.

Another example (e.g., example 8) relates to a previously described example (e.g., example 7) or to any of the examples described herein, further comprising that the processing circuitry is to monitor the memory accesses across a plurality of warm boot sequences of the virtual machine or equivalent virtual machine, and to generate the memory restoration template based on the monitored memory accesses occurring across the plurality of warm boot sequences.

Another example (e.g., example 9) relates to a previously described example (e.g., example 8) or to any of the examples described herein, further comprising that the processing circuitry is to omit memory accesses from the generation of the memory restoration template that occur non-consistently across the plurality of warm boot sequences.

Another example (e.g., example 10) relates to a previously described example (e.g., one of the examples 7 to 9) or to any of the examples described herein, further comprising that the processing circuitry is to monitor page faults to monitor the memory accesses.

Another example (e.g., example 11) relates to a previously described example (e.g., one of the examples 7 to 10) or to any of the examples described herein, further comprising that the processing circuitry is to use an event-based monitoring functionality of a processor being used to execute the virtual machine or equivalent virtual machine to monitor the memory accesses.

Another example (e.g., example 12) relates to a previously described example (e.g., one of the examples 1 to 11) or to any of the examples described herein, further comprising that restoring the subset of memory pages comprises decompressing the memory pages.

Another example (e.g., example 13) relates to a previously described example (e.g., example 12) or to any of the examples described herein, further comprising that the processing circuitry is to decompress at least some memory pages the subset of memory pages using a hardware-based decompression functionality of a processor being used to execute the virtual machine.

Another example (e.g., example 14) relates to a previously described example (e.g., one of the examples 1 to 13) or to any of the examples described herein, further comprising that the subset of memory pages comprises at least one of memory pages associated with state information of a hypervisor, with the state information being associated with the virtual machine, and memory pages being allocated to the virtual machine.

Another example (e.g., example 15) relates to a previously described example (e.g., one of the examples 1 to 14) or to any of the examples described herein, further comprising that the processing circuitry is to detect the virtual machine accessing one or more of the memory pages while the one or more memory pages are stored in the compressed memory pool, and to determine the impending access to the functionality provided by the virtual machine based on the detected access to the one or more memory pages.

Another example (e.g., example 16) relates to a previously described example (e.g., example 15) or to any of the examples described herein, further comprising that the processing circuitry is to detect the virtual machine accessing one or more of the memory pages while the one or more memory pages are stored in the compressed memory pool based on one or more page faults resulting from the access.

Another example (e.g., example 17) relates to a previously described example (e.g., one of the examples 1 to 16) or to any of the examples described herein, further comprising that the processing circuitry is to detect a warm boot sequence of the virtual machine, and to determine the impending access to the functionality provided by the virtual machine and restore the subset of memory pages based on the detection of the warm boot sequence.

Another example (e.g., example 18) relates to a previously described example (e.g., one of the examples 1 to 17) or to any of the examples described herein, further comprising that the virtual machine is one of a plurality of virtual machines being hosted by a computer system, each of the virtual machines hosting the functionality, wherein the processing circuitry is to monitor a utilization of the functionality being provided by the plurality of virtual machines over time, and to determine the impending access to the functionality provided by the virtual machine and restore the subset of memory pages based on the monitored utilization of the plurality of virtual machines over time.

Another example (e.g., example 19) relates to a previously described example (e.g., example 18) or to any of the examples described herein, further comprising that the processing circuitry is to predict the utilization of the functionality in the future based on the monitored utilization of the plurality of virtual machines over time, and to determine the impending access to the functionality provided by the virtual machine and restore the subset of memory pages based on the predicted utilization in the future.

An example (e.g., example 20) relates to a computer system (100) comprising the apparatus (10) according to one of the examples 1 to 19 or according to any other example and the memory (102).

An example (e.g., example 21) relates to a method for managing memory, the method comprising determining (160) an impending access to a functionality provided by a virtual machine. The method comprises restoring (170) a subset of memory pages associated with the virtual machine from a compressed memory pool to uncompressed memory according to a memory restoration template after determining the impending access to the virtual machine.

Another example (e.g., example 22) relates to a previously described example (e.g., example 21) or to any of the examples described herein, further comprising that the functionality provided by the virtual machine is a Function as a Service (FaaS) provided by the virtual machine.

Another example (e.g., example 23) relates to a previously described example (e.g., one of the examples 21 to 22) or to any of the examples described herein, further comprising that the virtual machine is one of a plurality of virtual machines providing the functionality being hosted by a computer system.

Another example (e.g., example 24) relates to a previously described example (e.g., one of the examples 21 to 23) or to any of the examples described herein, further comprising that the memory restoration template defines the subset of memory pages to be restored from the compressed memory pool to the uncompressed memory.

Another example (e.g., example 25) relates to a previously described example (e.g., example 24) or to any of the examples described herein, further comprising that at least one memory page associated with the virtual machine is omitted from restoration according to the memory restoration template.

Another example (e.g., example 26) relates to a previously described example (e.g., one of the examples 24 to 25) or to any of the examples described herein, further comprising that the memory restoration template is based on monitored memory accesses of at least one of the virtual machine, an equivalent virtual machine, and a hypervisor.

Another example (e.g., example 27) relates to a previously described example (e.g., example 26) or to any of the examples described herein, further comprising that the method comprises monitoring (110) memory accesses of at least one of the virtual machine, the equivalent virtual machine, and the hypervisor, and generating (120) the memory restoration template based on the monitored memory accesses.

Another example (e.g., example 28) relates to a previously described example (e.g., example 27) or to any of the examples described herein, further comprising that the method comprises monitoring (110) the memory accesses across a plurality of warm boot sequences of the virtual machine or equivalent virtual machine and generating (120) the memory restoration template based on the monitored memory accesses occurring across the plurality of warm boot sequences.

Another example (e.g., example 29) relates to a previously described example (e.g., example 28) or to any of the examples described herein, further comprising that the method comprises omitting (116) memory accesses from the generation of the memory restoration template that occur non-consistently across the plurality of warm boot sequences.

Another example (e.g., example 30) relates to a previously described example (e.g., one of the examples 27 to 29) or to any of the examples described herein, further comprising that the method comprises monitoring (112) page faults to monitor the memory accesses.

Another example (e.g., example 31) relates to a previously described example (e.g., one of the examples 27 to 30) or to any of the examples described herein, further comprising that the method comprises using (114) an event-based monitoring functionality of a processor being used to execute the virtual machine or equivalent virtual machine to monitor the memory accesses.

Another example (e.g., example 32) relates to a previously described example (e.g., one of the examples 21 to 31) or to any of the examples described herein, further comprising that restoring (170) the subset of memory pages comprises decompressing (175) the memory pages.

Another example (e.g., example 33) relates to a previously described example (e.g., example 32) or to any of the examples described herein, further comprising that the method comprises decompressing (175) at least some memory pages the subset of memory pages using a hardware-based decompression functionality of a processor being used to execute the virtual machine.

Another example (e.g., example 34) relates to a previously described example (e.g., one of the examples 21 to 33) or to any of the examples described herein, further comprising that the subset of memory pages comprises at least one of memory pages associated with state information of a hypervisor, with the state information being associated with the virtual machine, and memory pages being allocated to the virtual machine.

Another example (e.g., example 35) relates to a previously described example (e.g., one of the examples 21 to 34) or to any of the examples described herein, further comprising that the method comprises detecting (130) the virtual machine accessing one or more of the memory pages while the one or more memory pages are stored in the compressed memory pool and determining (160) the impending access to the functionality provided by the virtual machine based on the detected access to the one or more memory pages.

Another example (e.g., example 36) relates to a previously described example (e.g., example 35) or to any of the examples described herein, further comprising that the method comprises detecting (130) the virtual machine accessing one or more of the memory pages while the one or more memory pages are stored in the compressed memory pool based on one or more page faults resulting from the access.

Another example (e.g., example 37) relates to a previously described example (e.g., one of the examples 21 to 36) or to any of the examples described herein, further comprising that the method comprises detecting (140) a warm boot sequence of the virtual machine and determining (160) the impending access to the functionality provided by the virtual machine and restore the subset of memory pages based on the detection of the warm boot sequence.

Another example (e.g., example 38) relates to a previously described example (e.g., one of the examples 21 to 37) or to any of the examples described herein, further comprising that the virtual machine is one of a plurality of virtual machines being hosted by a computer system, each of the virtual machines hosting the functionality, wherein the method comprises monitoring (150) a utilization of the functionality being provided by the plurality of virtual machines over time, and determining (160) the impending access to the functionality provided by the virtual machine and restore the subset of memory pages based on the monitored utilization of the plurality of virtual machines over time.

Another example (e.g., example 39) relates to a previously described example (e.g., example 38) or to any of the examples described herein, further comprising that the method comprises predicting (155) the utilization of the functionality in the future based on the monitored utilization of the plurality of virtual machines over time and determining (160) the impending access to the functionality provided by the virtual machine and restore the subset of memory pages based on the predicted utilization in the future.

An example (e.g., example 40) relates to a computer system (100) comprising memory (102), wherein the computer system is configured to perform the method according to one of the examples 21 to 39 or according to any other example.

An example (e.g., example 41) relates to a non-transitory, computer-readable medium comprising a program code that, when the program code is executed on a processor, a computer, or a programmable hardware component, causes the processor, computer, or programmable hardware component to determine an impending access to a functionality provided by a virtual machine, and to restore a subset of memory pages associated with the virtual machine from a compressed memory pool to uncompressed memory according to a memory restoration template after determining the impending access to the virtual machine.

Another example (e.g., example 42) relates to a previously described example (e.g., example 41) or to any of the examples described herein, further comprising that the functionality provided by the virtual machine is a Function as a Service (FaaS) provided by the virtual machine.

Another example (e.g., example 43) relates to a previously described example (e.g., one of the examples 41 to 42) or to any of the examples described herein, further comprising that the virtual machine is one of a plurality of virtual machines providing the functionality being hosted by a computer system.

Another example (e.g., example 44) relates to a previously described example (e.g., one of the examples 41 to 43) or to any of the examples described herein, further comprising that the memory restoration template defines the subset of memory pages to be restored from the compressed memory pool to the uncompressed memory.

Another example (e.g., example 45) relates to a previously described example (e.g., example 44) or to any of the examples described herein, further comprising that at least one memory page associated with the virtual machine is omitted from restoration according to the memory restoration template.

Another example (e.g., example 46) relates to a previously described example (e.g., one of the examples 44 to 45) or to any of the examples described herein, further comprising that the memory restoration template is based on monitored memory accesses of at least one of the virtual machine, an equivalent virtual machine, and a hypervisor.

Another example (e.g., example 47) relates to a previously described example (e.g., example 46) or to any of the examples described herein, further comprising that the program code comprises machine-readable instructions to monitor memory accesses of at least one of the virtual machine, the equivalent virtual machine, and the hypervisor, and to generate the memory restoration template based on the monitored memory accesses.

Another example (e.g., example 48) relates to a previously described example (e.g., example 47) or to any of the examples described herein, further comprising that the program code comprises machine-readable instructions to monitor the memory accesses across a plurality of warm boot sequences of the virtual machine or equivalent virtual machine, and to generate the memory restoration template based on the monitored memory accesses occurring across the plurality of warm boot sequences.

Another example (e.g., example 49) relates to a previously described example (e.g., example 48) or to any of the examples described herein, further comprising that the program code comprises machine-readable instructions to omit memory accesses from the generation of the memory restoration template that occur non-consistently across the plurality of warm boot sequences.

Another example (e.g., example 50) relates to a previously described example (e.g., one of the examples 47 to 49) or to any of the examples described herein, further comprising that the program code comprises machine-readable instructions to monitor page faults to monitor the memory accesses.

Another example (e.g., example 51) relates to a previously described example (e.g., one of the examples 47 to 50) or to any of the examples described herein, further comprising that the program code comprises machine-readable instructions to use an event-based monitoring functionality of a processor being used to execute the virtual machine or equivalent virtual machine to monitor the memory accesses.

Another example (e.g., example 52) relates to a previously described example (e.g., one of the examples 41 to 51) or to any of the examples described herein, further comprising that restoring the subset of memory pages comprises decompressing the memory pages.

Another example (e.g., example 53) relates to a previously described example (e.g., example 52) or to any of the examples described herein, further comprising that the program code comprises machine-readable instructions to decompress at least some memory pages the subset of memory pages using a hardware-based decompression functionality of a processor being used to execute the virtual machine.

Another example (e.g., example 54) relates to a previously described example (e.g., one of the examples 41 to 53) or to any of the examples described herein, further comprising that the subset of memory pages comprises at least one of memory pages associated with state information of a hypervisor, with the state information being associated with the virtual machine, and memory pages being allocated to the virtual machine.

Another example (e.g., example 55) relates to a previously described example (e.g., one of the examples 41 to 54) or to any of the examples described herein, further comprising that the program code comprises machine-readable instructions to detect the virtual machine accessing one or more of the memory pages while the one or more memory pages are stored in the compressed memory pool, and to determine the impending access to the functionality provided by the virtual machine based on the detected access to the one or more memory pages.

Another example (e.g., example 56) relates to a previously described example (e.g., example 55) or to any of the examples described herein, further comprising that the program code comprises machine-readable instructions to detect the virtual machine accessing one or more of the memory pages while the one or more memory pages are stored in the compressed memory pool based on one or more page faults resulting from the access.

Another example (e.g., example 57) relates to a previously described example (e.g., one of the examples 41 to 56) or to any of the examples described herein, further comprising that the program code comprises machine-readable instructions to detect a warm boot sequence of the virtual machine, and to determine the impending access to the functionality provided by the virtual machine and restore the subset of memory pages based on the detection of the warm boot sequence.

Another example (e.g., example 58) relates to a previously described example (e.g., one of the examples 41 to 57) or to any of the examples described herein, further comprising that the virtual machine is one of a plurality of virtual machines being hosted by a computer system, each of the virtual machines hosting the functionality, wherein the program code comprises machine-readable instructions to monitor a utilization of the functionality being provided by the plurality of virtual machines over time, and to determine the impending access to the functionality provided by the virtual machine and restore the subset of memory pages based on the monitored utilization of the plurality of virtual machines over time.

Another example (e.g., example 59) relates to a previously described example (e.g., example 58) or to any of the examples described herein, further comprising that the program code comprises machine-readable instructions to predict the utilization of the functionality in the future based on the monitored utilization of the plurality of virtual machines over time, and to determine the impending access to the functionality provided by the virtual machine and restore the subset of memory pages based on the predicted utilization in the future.

An example (e.g., example 60) relates to an apparatus (10) for managing memory (105), the apparatus comprising interface circuitry (12), machine-readable instructions and processing circuitry (14) for executing the machine-readable instructions to determine an impending access to a functionality provided by a virtual machine, and to restore a subset of memory pages associated with the virtual machine from a compressed memory pool to uncompressed memory according to a memory restoration template after determining the impending access to the virtual machine.

An example (e.g., example 61) relates to a computer system (100) comprising the apparatus (10) according to example 60 or according to any other example and the memory (102).

An example (e.g., example 62) relates to a device (10) for managing memory (105), the device comprising means for processing for determining an impending access to a functionality provided by a virtual machine. The means for processing is suitable for (e.g., configured for) restoring a subset of memory pages associated with the virtual machine from a compressed memory pool to uncompressed memory according to a memory restoration template after determining the impending access to the virtual machine.

An example (e.g., example 63) relates to a computer system (100) comprising the device (10) according to example 62 or according to any other example and the memory (102).

An example (e.g., example 64) relates to a non-transitory machine-readable storage medium including program code, when executed, to cause a machine to perform the method of one of the examples 21 to 39 or according to any other example.

An example (e.g., example 65) relates to a computer program having a program code for performing the method of one of the examples the method of one of the examples 21 to 39 or according to any other example when the computer program is executed on a computer, a processor, or a programmable hardware component.

An example (e.g., example 66) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory, computer-readable medium comprising a program code that, when the program code is executed on a processor, a computer, or a programmable hardware component, causes the processor, computer, or programmable hardware component to:
determine an impending access to a functionality provided by a virtual machine;
restore a subset of memory pages associated with the virtual machine from a compressed memory pool to uncompressed memory according to a memory restoration template after determining the impending access to the virtual machine.

2. The non-transitory, computer-readable medium according to claim 1, wherein the functionality provided by the virtual machine is a Function as a Service (FaaS) provided by the virtual machine.

3. The non-transitory, computer-readable medium according to claim 1, wherein the virtual machine is one of a plurality of virtual machines providing the functionality being hosted by a computer system.

4. The non-transitory, computer-readable medium according to claim 1, wherein the memory restoration template defines the subset of memory pages to be restored from the compressed memory pool to the uncompressed memory.

5. The non-transitory, computer-readable medium according to claim 4, wherein at least one memory page associated with the virtual machine is omitted from restoration according to the memory restoration template.

6. The non-transitory, computer-readable medium according to claim 4, wherein the memory restoration template is based on monitored memory accesses of at least one of the virtual machine, an equivalent virtual machine, and a hypervisor.

7. The non-transitory, computer-readable medium according to claim 6, wherein the program code comprises machine-readable instructions to monitor memory accesses of at least one of the virtual machine, the equivalent virtual machine, and the hypervisor, and to generate the memory restoration template based on the monitored memory accesses.

8. The non-transitory, computer-readable medium according to claim 7, wherein the program code comprises machine-readable instructions to monitor the memory accesses across a plurality of warm boot sequences of the virtual machine or equivalent virtual machine, and to generate the memory restoration template based on the monitored memory accesses occurring across the plurality of warm boot sequences.

9. The non-transitory, computer-readable medium according to claim 8, wherein the program code comprises machine-readable instructions to omit memory accesses from the generation of the memory restoration template that occur non-consistently across the plurality of warm boot sequences.

10. The non-transitory, computer-readable medium according to claim 7, wherein the program code comprises machine-readable instructions to monitor page faults to monitor the memory accesses.

11. The non-transitory, computer-readable medium according to claim 7, wherein the program code comprises machine-readable instructions to use an event-based monitoring functionality of a processor being used to execute the virtual machine or equivalent virtual machine to monitor the memory accesses.

12. The non-transitory, computer-readable medium according to claim 1, wherein restoring the subset of memory pages comprises decompressing the memory pages.

13. The non-transitory, computer-readable medium according to claim 12, wherein the program code comprises machine-readable instructions to decompress at least some memory pages the subset of memory pages using a hardware-based decompression functionality of a processor being used to execute the virtual machine.

14. The non-transitory, computer-readable medium according to claim 1, wherein the subset of memory pages comprises at least one of memory pages associated with state information of a hypervisor, with the state information being associated with the virtual machine, and memory pages being allocated to the virtual machine.

15. The non-transitory, computer-readable medium according to claim 1, wherein the program code comprises machine-readable instructions to detect the virtual machine accessing one or more of the memory pages while the one or more memory pages are stored in the compressed memory pool, and to determine the impending access to the functionality provided by the virtual machine based on the detected access to the one or more memory pages.

16. The non-transitory, computer-readable medium according to claim 15, wherein the program code comprises machine-readable instructions to detect the virtual machine accessing one or more of the memory pages while the one or more memory pages are stored in the compressed memory pool based on one or more page faults resulting from the access.

17. The non-transitory, computer-readable medium according to claim 1, wherein the program code comprises machine-readable instructions to detect a warm boot sequence of the virtual machine, and to determine the impending access to the functionality provided by the virtual machine and restore the subset of memory pages based on the detection of the warm boot sequence.

18. The non-transitory, computer-readable medium according to claim 1, wherein the virtual machine is one of a plurality of virtual machines being hosted by a computer system, each of the virtual machines hosting the functionality, wherein the program code comprises machine-readable instructions to monitor a utilization of the functionality being provided by the plurality of virtual machines over time, and to determine the impending access to the functionality provided by the virtual machine and restore the subset of memory pages based on the monitored utilization of the plurality of virtual machines over time.

19. The non-transitory, computer-readable medium according to claim 18, wherein the program code comprises machine-readable instructions to predict the utilization of the functionality in the future based on the monitored utilization of the plurality of virtual machines over time, and to determine the impending access to the functionality provided by the virtual machine and restore the subset of memory pages based on the predicted utilization in the future.

20. An apparatus for managing memory, the apparatus comprising interface circuitry, machine-readable instructions and processing circuitry for executing the machine-readable instructions to:
determine an impending access to a functionality provided by a virtual machine;
restore a subset of memory pages associated with the virtual machine from a compressed memory pool to uncompressed memory according to a memory restoration template after determining the impending access to the virtual machine.

21. A computer system comprising the apparatus according to claim 20 and the memory.

22. A method for managing memory, the method comprising:
determining an impending access to a functionality provided by a virtual machine;
restoring a subset of memory pages associated with the virtual machine from a compressed memory pool to uncompressed memory according to a memory restoration template after determining the impending access to the virtual machine.
